(19) United States
(12) Patent Application Publication
(10) Pub. No.: US 2011/0183203 A1
(43) Pub. Date: Jul. 28, 2011

(54) Polymer supported electrodes

(75) Inventors: Chunsheng Du, Fremont, CA (US); Clark Dong, Los Gatos, CA (US); Lawrence S. Pan, Los Gatos, CA (US); Shufu Peng, Sunnyvale, CA (US)

(73) Assignee: Molecular Nanosystems, Inc.

(21) Appl. No.: 12/931,320

(22) Filed: Jan. 27, 2011

Related U.S. Application Data
(60) Provisional application No. 61/298,893, filed on Jan. 27, 2010.

(51) Int. Cl. H01M 4/62; B05D 5/12; B82Y 30/00

(52) U.S. Cl. 429/217; 427/77; 427/78; 427/470; 977/742

(57) ABSTRACT

Methods and devices arising from the practice thereof for making and using battery electrodes formed onto ion permeable, electrically non-conductive substrates, preferably battery separators are disclosed herein. Electrodes are formed onto substrates using a variety of methods including, but not limited to, spray coating and electrophoretic deposition. Electrically conductive layers may be applied to the electrode coating layer side opposite or adjacent to the substrate to act as current collectors for the battery. Multilayer devices having alternating layers of conductive layers, electrode layers and substrates, wherein the conductive layers may be in electrical communication with other conductive layers to form a battery.

### CROSS-REFERENCE TO RELATED APPLICATIONS

This application claim priority under 35 U.S.C. §119(e) to U.S. Provisional Patent Application Ser. No. 61/298,893 by Du, et al., filed on Jan. 27, 2010, which is herein incorporated by reference in its entirety for all purposes, and the specific purposes described herein.

### STATEMENT REGARDING FEDERALLY SPONSORED RESEARCH OR DEVELOPMENT

No part of the invention described herein was the result of Federally sponsored research or development.

### FIELD OF THE INVENTION

The invention relates to the fields of electrode manufacturing, web coating, energy storage, energy efficiency, batteries, secondary batteries, and lithium ion batteries.

### BACKGROUND

Rechargeable batteries play an important role in everyday modern life. From portable electronics to hybrid electric and electric vehicles, rechargeable batteries are an indispensable part of our society. The advent of lithium ion batteries was an important development in the field of rechargeable batteries. Lithium ion batteries typically comprise two electrodes, those being the anode and the cathode, each formed separately on a metal foil backing called a current collector. In a cell, the exposed surfaces of the electrodes are faced towards each other and an ion permeable, electrically insulating barrier membrane, called the separator, is disposed between the open electrode faces to prevent their direct contact. An electrolyte containing solution is introduced between the layers to provide a medium for ion conduction between the electrodes through the separator while electrons migrate between current collectors via an external electrical circuit to produce work.

Traditionally, lithium ion battery electrodes are made by spreading a thick slurry that contains active material particles onto a metal foil support that also acts as a current collector. One reason for applying liquid electrode coatings to metal foil supports is to ensure good electrical contact between the electrode and the current collector bound to it. To act as a support for manufacturing, however, the metal foils need to be sufficiently thick enough to withstand the mechanical forces applied to the foil during unwinding, processing, and rewinding during production activities.

In many situations, the thickness of a metal foil is driven more by mechanical issues than electrical requirements. As a result, an electrode often requires a thicker foil than is electrically necessary. The additional metal foil thickness adds to the overall weight, volume, and cost of the resulting battery. Accordingly, there is a need to reduce the amount of metal foil needed to produce a battery because lowering costs and reducing weight in lithium ion batteries are important goals towards the electrification of transportation, an important step in the reduction of human-caused greenhouse gas emission.

An example of a typical lithium ion battery cell found in the prior art can be seen in FIGS. 1a & 1b. Shown in exploded cross-section, the cell comprises Cathode Current Collector 100 with Cathode 110 adhered thereto. Likewise, Anode 130 is adhered to Anode Current Collector 140. Anode 130 and Cathode 110 are adhered to their respective Current Collectors 140 and 100 as a result of manufacturing where cathodes are applied as slurry mixtures onto metal foil current collectors and dried prior to assembly into a cell. Once dried, the electrode/current collector assemblies are sandwiched together with Separator 120 therebetween to prevent direct contact between the anode and cathode.

FIGS. 2a & 2b depict another typical battery cell with a thermal shut-down separator shown in cross-section found in the prior art. Here, the separator comprises three parts, Outer Layers 125a and 125c with Shutdown Separator 125b therebetween. When a cell containing a shutdown separator experiences higher than normal operating temperatures, Shutdown Separator 125b softens to close off its pores thus rendering it non-ion-permeable. In-turn, the cell shuts down due to the breaking of the electrolyte circuit within the cell between the anode and cathode. FIGS. 3a & 3b depict a shutdown separator similar to that in FIGS. 2a & 2b. FIGS. 4a through 4c depict the shutdown separator in FIGS. 3a & 3b wherein when heat is added, Shutdown Separator 125b transforms into Barrier 125b-1 whose pores have closed due to softening of the polymer that comprises the separator.

The invention disclosed herein provides for methods and devices arising therefrom for making batteries with minimal to zero amounts of metal foil to lower costs and reduce battery weight.

### BRIEF SUMMARY OF THE INVENTION

The invention provides, in one aspect, methods for making battery electrodes comprising the steps of: providing an ion permeable electrically insulating substrate having a surface; applying an active material suspension onto the substrate surface to produce an active material layer having first and second active material layer surfaces, the first active material layer surface being adjacent to the substrate surface, the active material suspension comprising: active material particles capable of reversibly lithiating and de-lithiating; conductive particles capable of conducting electrons; and, binder polymer; applying a conductive layer upon the active material layer wherein the conductive layer is in electrical communication with the coating layer.

In some embodiments, the substrate may comprise a battery separator, preferably a battery separator suitable for use in lithium ion batteries. The battery separator may comprise a material selected from the group of polymers and polymer precursors including, but not limited to: polyethylene oxide (PEO), polyvinylidene fluoride (PVDF), polytetrafluoroethylene (PTFE), polyurethane, polyacrylonitrile (PAN), polymethylmethacrylate (PMMA), polytetraethylene glycol diacrylate, and, copolymer.

In some embodiments, the substrate may comprise a first microporous membrane and a second ceramic/porous polymer composite layer, wherein the ceramic composite layer consists of a porous polymer and inorganic particles composed as a matrix, the matrix being one or a combination of: silicon dioxide (SiO₂); aluminum oxide (Al₂O₃); calcium carbonate (CaCO₃); titanium dioxide (TiO₂); SiS₂; and, SiPO₄. Preferably, the inorganic particles make up from 5% to 80% by weight of the ceramic composite layer In other embodiments, the inorganic particles make up from 40% to 60% by weight of the ceramic composite layer.

In some embodiments, the substrate may comprise one or a combination of: polyacrylates (AA); acrylonitrile-butadiene-styrene (ABS); ethylene vinyl alcohol (E/VAL); fluoroplastics (PTFE), (FEP, PFA, CTFE); high impact polystyrene (HIPS); melamine formaldehyde (MF); poly liquid crystal polymer (LCP); polyacetal (POM); acrylo nitrile (PAN); phenol-formaldehyde plastic (PF); polyamide (PA); polyamide-imide (PAI); polyaryletherketone (PAEK)′ polyetheretherketone (PEEK); 2. cis 1,4-poly butadiene (PBD); trans 1,4-poly butadiene (PBD); poly 1-butene (PB); poly butylene terephthalate (PBT); poly caprolactam; poly carbonate (PC); polycarbonate/acrylonitrile butadiene styrene (PC/ABS); poly 2,6-dimethyl-1,4-phenylene ether (PPE); polydicyclopentadiene (PDCP); polyester (PL); poly ether ether ketone (PEEK); poly etherimide (PEI); poly ethylene (PE, LDPE, MDPE, HDPE, UHDPE); polyethylenechlorinates (PEC); poly(ethylene glycol) (PEG); poly ethylene hexamethylene dicarbamate (PEHD); poly ethylene oxide (PEO); polyethersulfone (PES); poly ethylene sulphide (PES); poly ethylene terephthalate (PET); Phenolics (PF); poly hexamethylene adipamide (PHMA); poly hexamethylene sebacamide (PHMS); polyhydroxyethylmethacrylate (HEMA)poly imide (PI); poly isobutylene (PIB); polyektone (PK); polylactic acid (PLA); poly methyl methacrylate (PMMA); poly methyl pentene (PMP); poly m-methyl styrene (PMMS); poly p-methyl styrene (PPMS); poly oxymethylene (POM); poly pentamethylene hexamethylene dicarbamate (PPHD); poly m-phenylene; isophthalamide (PMIA); poly phenylene oxide (PPO); poly p-phenylene sulphide (PPS); poly p-phenylene terephthalamide (PPTA); polyphthalamide (PTA); poly propylene (PP); poly propylene oxide (PPDX); poly styrene (PS); polysulfone (PSU); poly tetrafluoro; ethylene (PTFE); poly(trimethylene terephthalate) (PTT); poly polyurethane (PU); Polyvinyl butyral (PVB); poly vinyl chloride (PVC); polyvinylidene chloride (PVDC); poly vinyledene fluoride (PVDF); poly vinyl methyl ether (PVME); poly(vinyl pyrrolidone) (PVP)silicone(SI); styrene-acrylonitrile resin (SAN); thermoplastic elastomers (TPE); thermoplastic polymer (TP); and, urea-formaldehyde (UF).

In some embodiments, the electrode support may act in a way that helps to prevent thermal runaway resulting from dendrite formation within the battery, preferably by having the electrode support comprises two or more layers of polymer sheets with different melting points being laminated to provide the electrode support.

In one aspect of the invention, the support surface may further comprise a hydrophilic coating upon the surface. In some embodiments, the substrate may have upon its surface a hydrophilic coating comprising a polymer, or combination of polymers, such as: acrylonitrile butadiene styrene (ABS); polyacrylonitrile (PAN) or Acrylic; polybutadiene; poly(butylene terephthalate) (PBT); poly(ether sulphone) (PES, PES/PEES); polyether ether ketones (PEEK, PES/PEEK); polyethylene (PE); poly(ethylene glycol) (PEG); poly(ethylene terephthalate) (PET); polypropylene (PP); polytetrafluoroethylene (PTFE); styrene-acrylonitrile resin (SAN); poly(trimethylene terephthalate) (PTT); polyurethane (PU); Polyvinyl butyral (PVB); polyvinylchloride (PVC); polyvinylidenedifluoride (PVDF); poly(vinyl pyrrolidone) (PVP); polyhydroxyethylmethacrylate (HEMA); butyl acrylate, 2-ethylhexyl acrylate, methyl acrylate, ethyl acrylate, acrylonitrile, methyl methacrylate, trimethylolpropane triacrylate (TMPTA), and, cyanoacrylate.

In some embodiments, the applying step may comprise a coating method that includes one or a combination of: spray deposition; electrostatic assisted spray deposition; electrokinetic deposition; electrophoretic deposition; mist deposition; curtain coating; slurry coating; slot-die coating; gravure coating; and, coating involving a doctor blade.

In some embodiments, the first conductive layer may comprise a metal foil, the metal foil adhering to the coating layer upon contact, preferably wherein the metal foil adheres to the coating layer through a conductive adhesive. In some embodiments, the first conductive layer is applied to the electrode in liquid form, and where preferably the liquid comprises conductive particles and a binder polymer. In preferred embodiments, the conductive particles may comprise carbon, and more preferably, carbon nanotubes.

In preferred embodiments, the active material may comprise a material comprising one or a combination of: LiC₆; LiCo_{1/3}Ni_{1/3}Mn_{1/3}O₂; LiCoO₂; LiFePO₄; Li₂FePO₄F; Li_{4.4}Ge; Li(LiₐNiₓMn_{y}CO_{z})O₂; LiMnO₂; LiMn₂O4; LiNiₓCO_{y}Mn_{z}O₂; LiNiO₂; Li_{4.4}Si; Li₄Ti₅O₁₂; Si; Sn; SnO₂; and, graphite. In particularly preferred embodiments, the active material may comprise Li₂Mn₂₋ₓMeₓO_{4-z}F_{z}, wherein Me is selected from the group consisting of: aluminum; chromium; zinc; cobalt; nickel; lithium; magnesium; iron; copper; titanium; and, silicon, and wherein x and z range from 0 to 0.5.

Another aspect of the invention provides for methods of applying materials to substrates. In a highly preferred embodiment, the active material suspension may be applied to the substrate surface by spraying, preferably by air spraying, airless spraying, or, electrostatic spraying. In some embodiments, the active material suspension may be applied to the substrate surface by electrokinetic deposition, preferably by electrophoretic deposition. In some embodiments, material application is done by slurry coating, preferably by slot-die or gravure coating. In some embodiments, the substrate moves past an active material suspension applicator during the applying step. Preferably, the substrate is unwound from a reel prior to the applying step and, the substrate is rewound subsequent to the applying step.

In some embodiments, the invention provides for an electrode comprising a substrate having a surface and being ion permeable and electrically insulating. In some embodiments, an electrode may comprise an active material layer having first and second active material layer surfaces, the first active material layer surface being bonded to the substrate surface, the active material layer comprising: active material particles capable of reversibly lithiating and de-lithiating; conductive particles capable of conducting electrons; and, binder polymer; a conductive layer upon the active material layer, wherein the conductive layer is in electrical communication with the coating layer. In some embodiments, the conductive particles comprise carbon nanotubes, preferably multi-walled carbon nanotubes.

In some embodiments, the substrate may comprise a battery separator membrane, preferably comprising one or more polymers. In some embodiments, the substrate may comprise at least two different polymer types, at least two types having different melting temperatures. In some embodiments, the substrate may comprise glass fiber. In some preferred embodiments, the substrate may comprise a plurality of polymer layers, preferably three polymer layers. In some preferred embodiments, the substrate may comprise a thermal shutdown battery separator.

In some embodiments, the substrate and the active material layer may be adhesively bonded to each other, preferably where the substrate and active materials are adhered together by a conductive adhesive comprising conductive particles, preferably carbon nanotubes.

In one aspect of the invention, the electrode support may act as a battery separator. In some embodiments, the electrode support functions as a battery separator that comprises a polymer sheet having thereupon an electrode material, the polymer sheet being disposed adjacent another electrode, for example, but not limited to, a cathode or an anode, wherein the electrode support with its electrode material and the other electrode are situated within a liquid electrolyte, a gel electrolyte, or a molten salt battery. In preferred embodiments, the separator prevents physical contact between anode and cathode material and may serve as an electrolyte reservoir to provide for ionic transport between the electrodes through the pores of the separator. In some embodiments, the separator may participate in an electrochemical reaction, for example, but not limited to, lithium ion secondary storage processes. In some embodiments, ion permeability and dielectric properties of the separator may be improved to improve energy density, power density, cycle life and safety of the battery, and preferably the separator may be stable against acidic, basic, aqueous, organic, and electrolytic battery environments. The preferred separator may have additives that afford chemical and electrochemical stability, and mechanical strength to prevent dendrite growth. Structural and/or chemical variants may be incorporated into the battery and/or the separator to minimize self-discharge and penetration of metal dendrites formed during charging for a secondary battery. For high energy and power densities, the separator should be very thin, highly porous, and capable of withstanding high temperature incurred by fast discharge.

In some embodiments, the electrode support may comprise two or more polymer materials each having a different or the same melting temperature.

In some embodiments, the electrode support may act in a way that helps to prevent thermal runaway resulting from dendrite formation within the battery in that the electrode support comprises two or more layers of polymer sheets with different melting points being laminated to provide the electrode support, when used as a battery separator, with thermal shutdown capability.

Another aspect of the invention provides for battery separators having disposed thereon a material capable of reversibly sequestering metal atoms.

In preferred embodiments, the metal atoms are alkaline metal atoms. In particularly preferred embodiments, the alkaline metal atom may be lithium. In some embodiments, the metal atom may be a metal ion. A highly preferred embodiment, the metal ion may be lithium ion.

### BRIEF DESCRIPTION OF THE SEVERAL VIEWS OF THE DRAWINGS

FIGS. 1a & 1b depict a typical battery cell shown in cross-section found in the PRIOR ART.

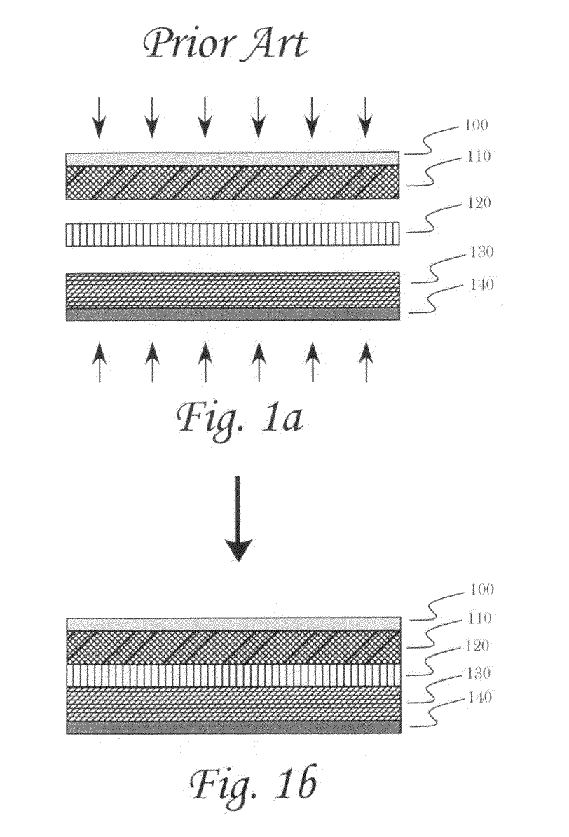

FIGS. 2a & 2b depict another typical battery cell with a thermal shut-down separator shown in cross-section found in the PRIOR ART.

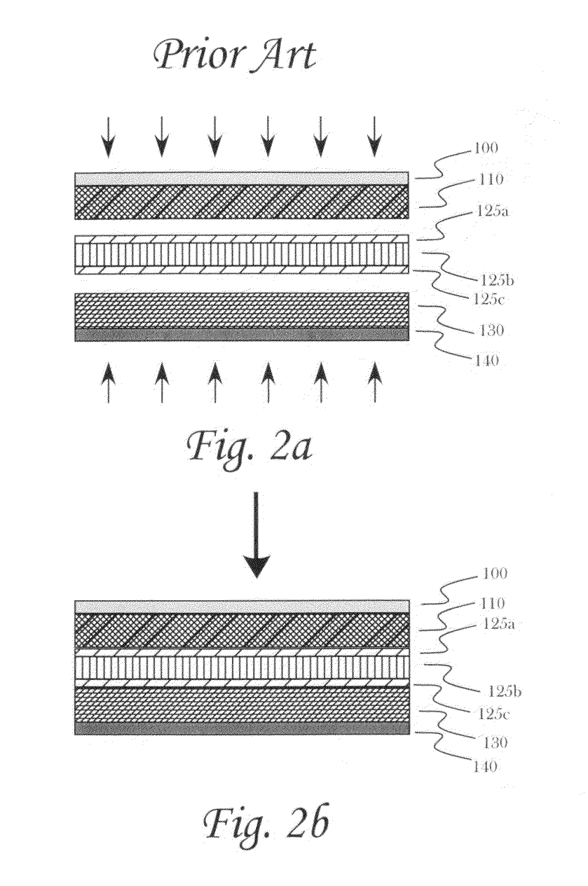

FIGS. 3a & 3b depict a typical three-layer battery separator found in the PRIOR ART.

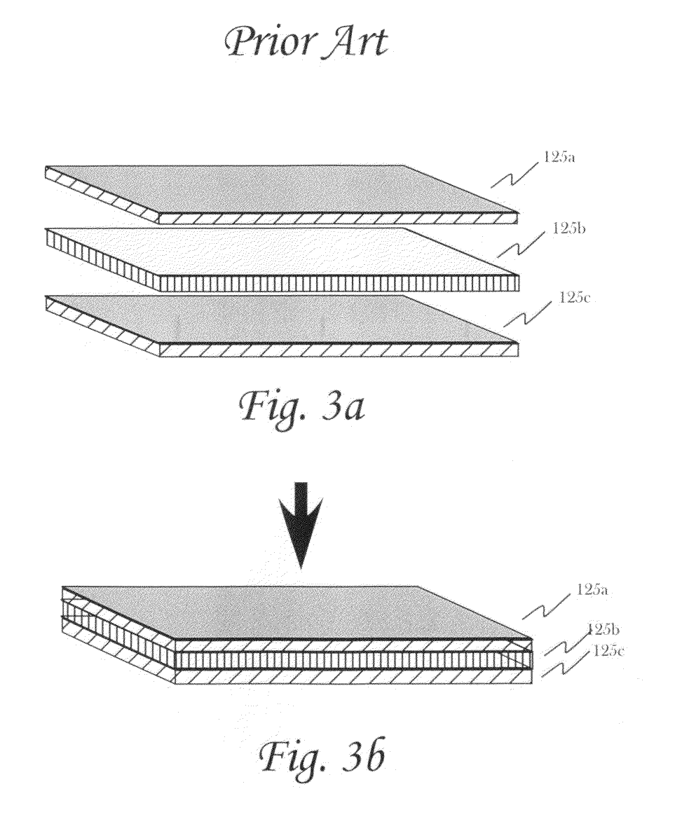

FIGS. 4a through 4c depict a typical three layer thermal shut-down separator found in the PRIOR ART.

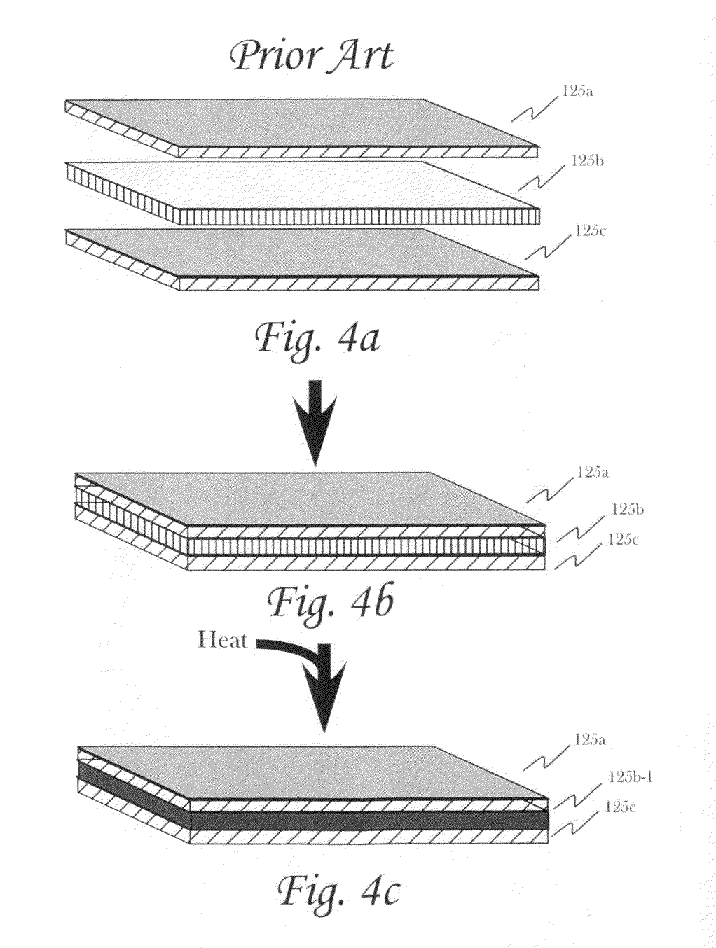

FIGS. 5a & 5b depict a preferred embodiment of the invention of a battery cell in cross-section showing the electrode materials bonded to the separator prior to application of the current collectors.

FIGS. 6a through 6c depict an exemplary cell embodiment of the invention.

FIG. 7 depicts a spiral wound cell of an exemplary embodiment of the invention.

FIGS. 8a & 8b depict an exemplary embodiment cell of the invention in perspective view.

FIGS. 9a through 9e depict stepwise the preferred method for making exemplary electrodes of the invention.

FIGS. 10a & 10b depict, in perspective view, an exemplary cell provided for by the invention.

FIG. 11 depicts a knife-over-roller coating system suitable for practicing certain embodiments of the invention.

FIG. 12 depicts a slot-die coater systems suitable for practicing certain embodiments of the invention.

FIG. 13 depicts a spray/dry coating system suitable for practicing preferred embodiments of the invention.

FIG. 14 depicts an apparatus for performing electrophoretic deposition suitable for practicing certain embodiments of the invention.

FIG. 15 depicts another apparatus for performing electrophoretic deposition suitable for practicing certain embodiments of the invention.

### DETAILED DESCRIPTION OF THE INVENTION

The invention provides, in one aspect, for rechargeable battery cells manufactured by applying electrode material to a surface of a non-electrically conductive substrate. The non-electrically conductive substrate may be permeable, or non-permeable to ions. In addition to applying the electrode material to the surface of the substrate, an additional electrically conductive layer may be applied to the surface of the substrate prior to applying the electrode material to provide for a current collecting conductive layer adjacent the substrate, or the conductive layer may be applied after the application of the electrode material to the surface of the substrate to provide a current collector conductive layer distal to the substrate. In some embodiments, the current collector layer may further comprise an electrically conductive tab for establishing electrical communication between the electrode and an electrical circuit external to the cell.

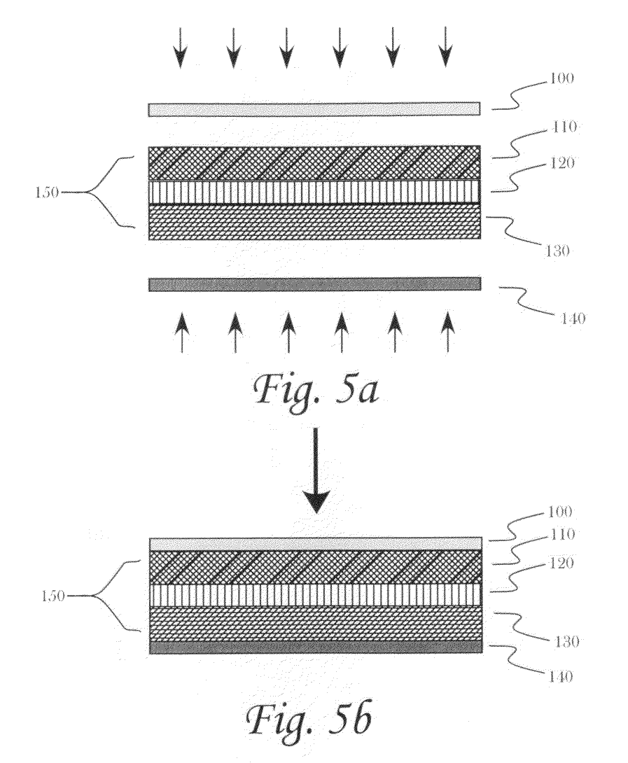

The invention provides for electrodes that may be used in different cell configurations. FIGS. 5a & 5b depict a preferred embodiment of the invention of a battery cell in cross-section showing the electrode materials bonded to the separator prior to application of the current collectors. Here, Separator 120 has bonded thereto Cathode 110 and Anode 130, independent of Current Collectors 100 and 140. FIG. 5a depicts Electrode Sandwich 150 comprises of Cathode 110 and Anode 130 bonded to opposing sides of Separator 120. As shown in FIG. 5b, Cathode Current Collector 100 and Anode Current Collector 140 are then bonded to the pre-formed Electrode Sandwich 150 to form a cell. Advantages of using Separator 120 as a support for making electrodes include 1) polymer separators tends to have greater tensile strength per unit mass than metal foils, and 2) the thickness of the current collector is liberated from thickness requirements needed to overcome the mechanical forces of the electrode coating process.

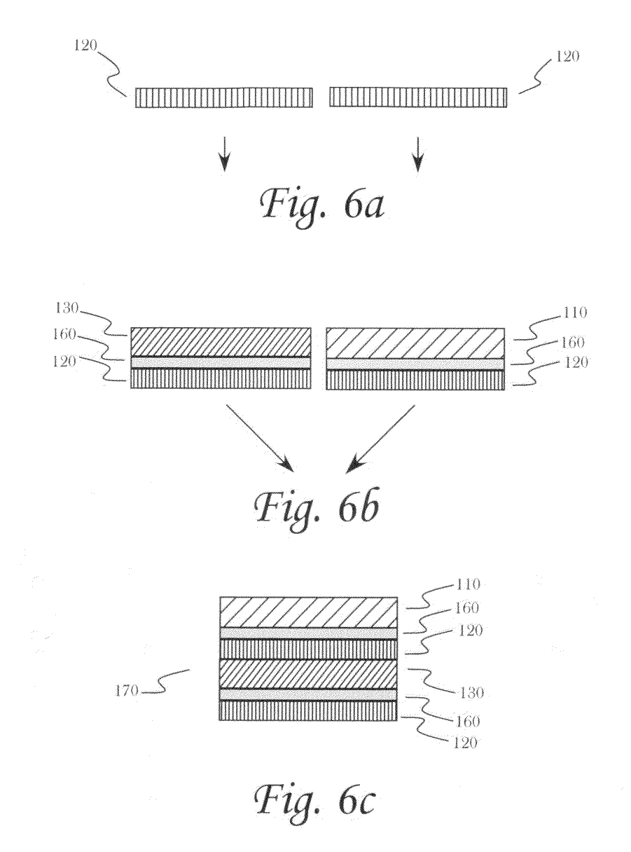

Another cell configuration offered by the invention is shown in FIGS. 6a through 6c. In FIG. 6a, Separator 120 is coated with Conductive Layer 160 which functions as a current collector. FIG. 6b shows the application of Anode 130 and Cathode 110 onto Conductive Layers 160. Cell 170, shown in FIG. 6c, is formed by stacking Anode 110 with its corresponding Conductive Layer 160 and Separator 120, directly on top of Cathode 130 with its corresponding Conductive Layer 160 and Separator 120 such that Cathode 130 is flanked by its own Separator 120, and Separator 120 associated with Anode 110. Leads, not shown, can be electrically connected to each Conductive Layer 160 to connect Cell 170 with an external electrical circuit, not shown.

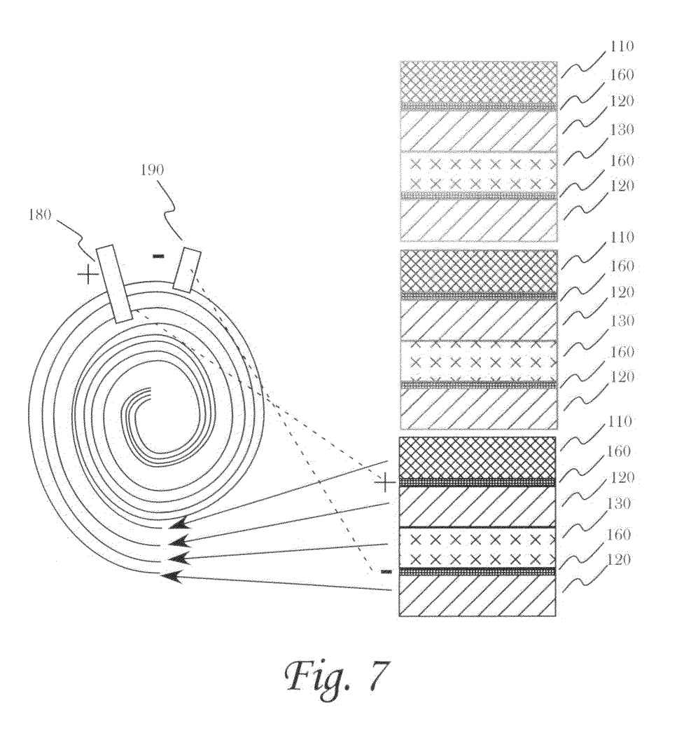

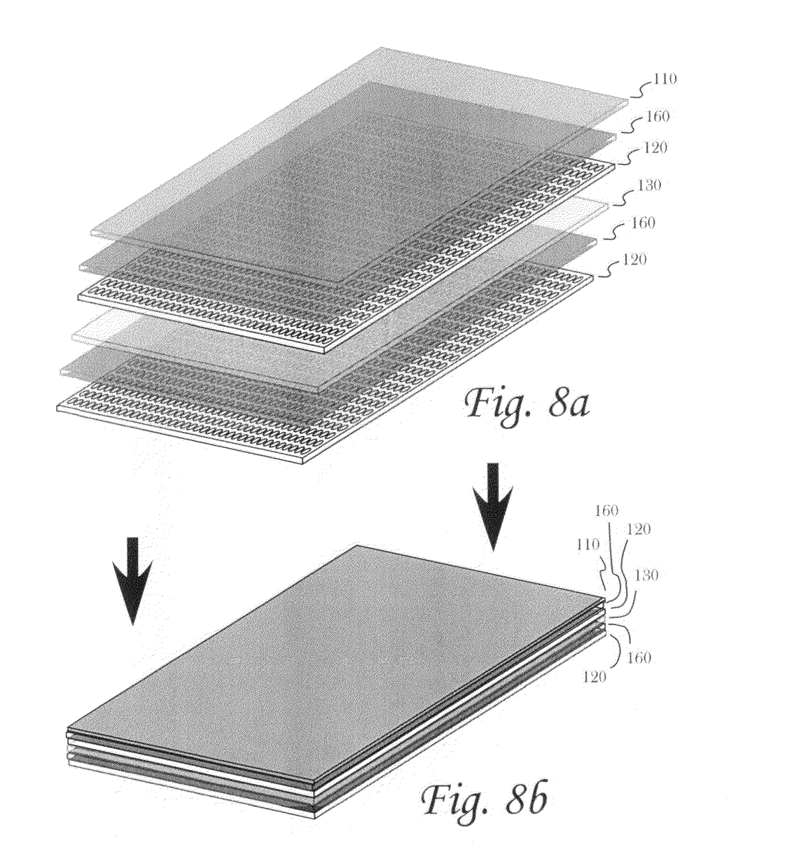

In one embodiment, the electrodes provided for by the invention may be mated together and rolled up into a spiral or “jelly” roll configuration as shown in FIG. 7. On the right side of FIG. 7 is shown stacked layers of the spiral cell. Because each cell is separated from the other by an ion permeable separator, Separator 120, ions migrating between anodes and cathodes can travel either in to a cell region of the immediate layer, or to the cell region of an adjacent layer. Having two directions for ion migration effectively reduces the ion mobility impedance of the electrode by approximately one half. In turn, decreased ion impedance can result in higher power cells, or permit thicker electrodes providing higher storage capacity at a given power rating. FIGS. 8a & 8b depict a perspective view of the flat cell shown in FIG. 5. A flat cell such as that shown in FIGS. 8a and 8b are suitable for pouch cell type battery packs.

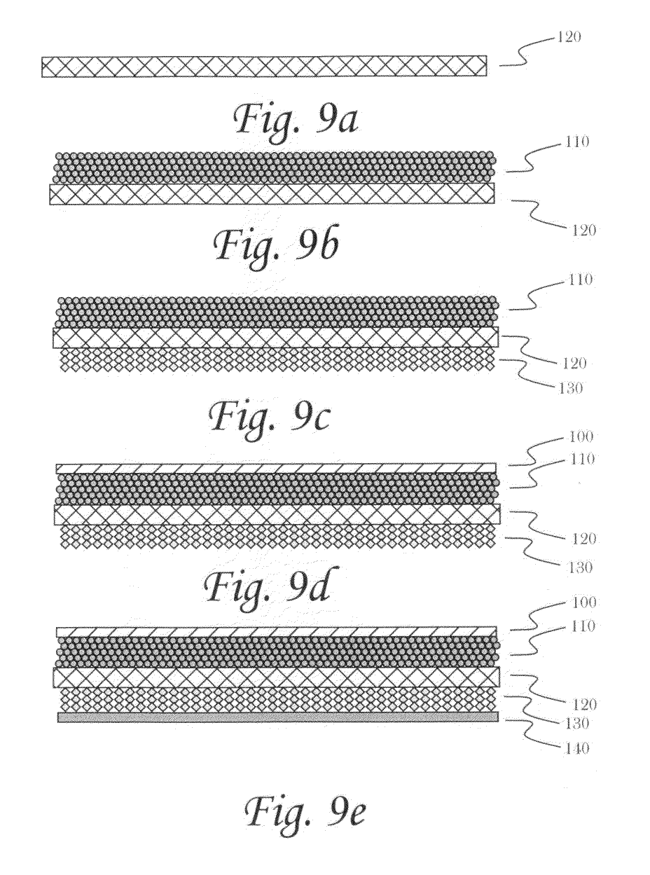

The invention provides, in one aspect, for cells having in-situ formed current collectors. FIGS. 9a through 9e depict stepwise the preferred method for making exemplary electrodes of the invention by forming in-situ Current Collectors 100 and 140. Once Cathode 110 and Anode 130 are formed onto Separator 120, Current Collectors 100 and 140 are bonded simultaneously or sequentially to the exposed surface of each electrode. In one embodiment, the current collectors are formed by coating a liquid containing a conductive agent that, upon drying, forms a conductive layer upon the electrode layers. An example would be a conductive paint containing conductive particles such as metals like gold, silver, copper, aluminum and other conductive metals. Another example would be to use carbon based conductive particles such as, but not limited to, carbon black, carbon nanotubes, carbon fiber, graphite, graphene, and other conductive forms of carbon.

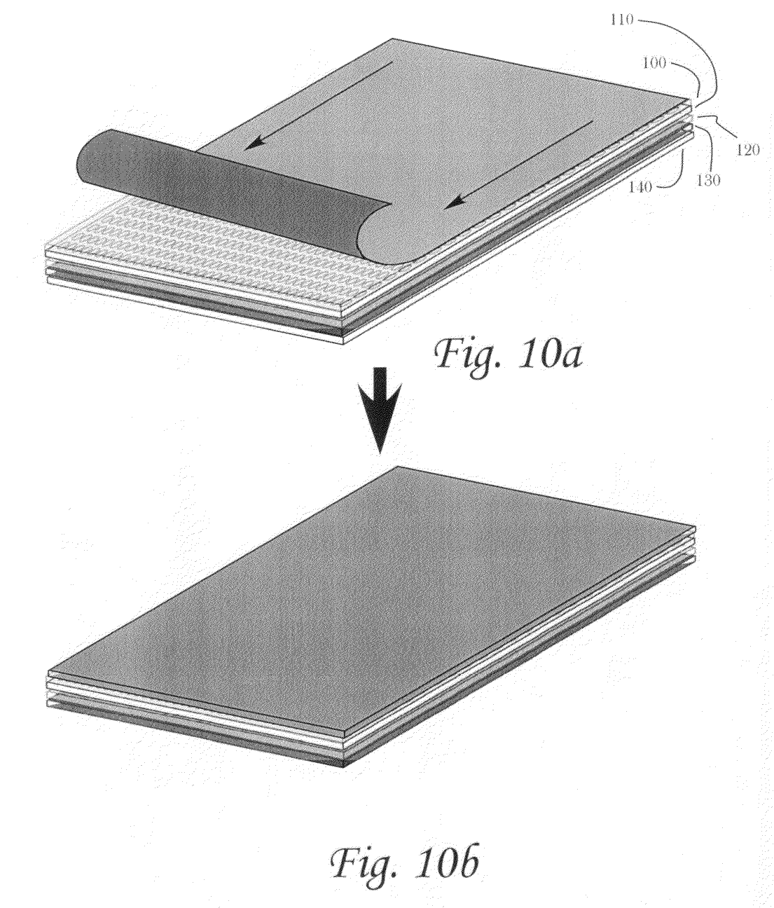

The conductive coating described in the preceding paragraph may further be used to affix a thin metal foil to serve as a current conductor. As shown in FIGS. 10a & 10b a cell is formed by layering foil onto the exposed electrode surface of the electrode/separator sandwich to form a cell comprising: a Cathode Current Collector (foil) adhered to Cathode 110 which is adhered to Separator 120, which is adhered to Anode 130 which is adhered to Anode Current Collector 140.

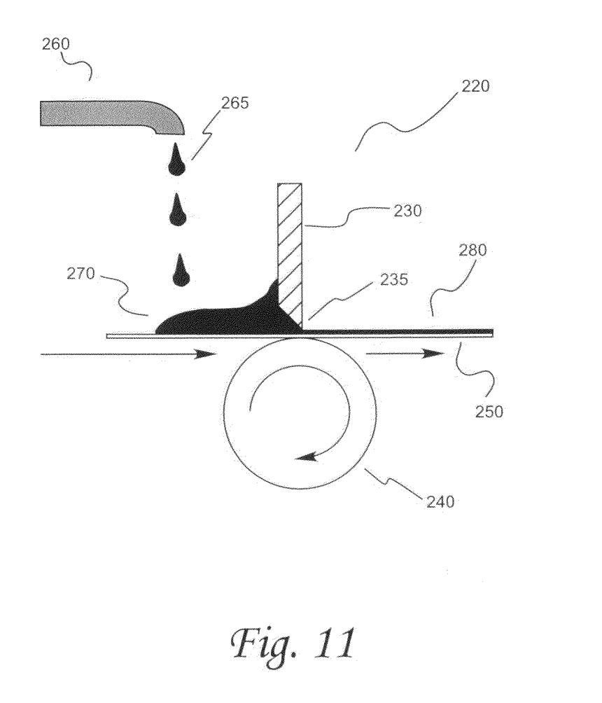

FIG. 11 depicts a knife-over-roller coating system found in the prior art which can be used to coat the separators and non-conductive supports of the invention. Knife-Over-Blade Coater 220 comprises Knife 230 in close proximity to Roller 240 wherein Trailing Knife Edge 235 is generally situated perpendicular to the closest point on Roller 240 forming an imaginary line bisecting Roller 240 in cross-section. Ribbon 250 moves in a direction tangential to Roller 240 where Trailing Knife Edge 235 points down. A supply of Coating Slurry 265 is delivered by Supply Line 260 to the leading side of Knife 230 where slurry is dripped to form Slurry Puddle 270. The gap between Trailing Knife Edge 235 and Ribbon 250 is controlled by the position of Roller 240. The resulting gap dictates the thickness of the wet slurry coating.

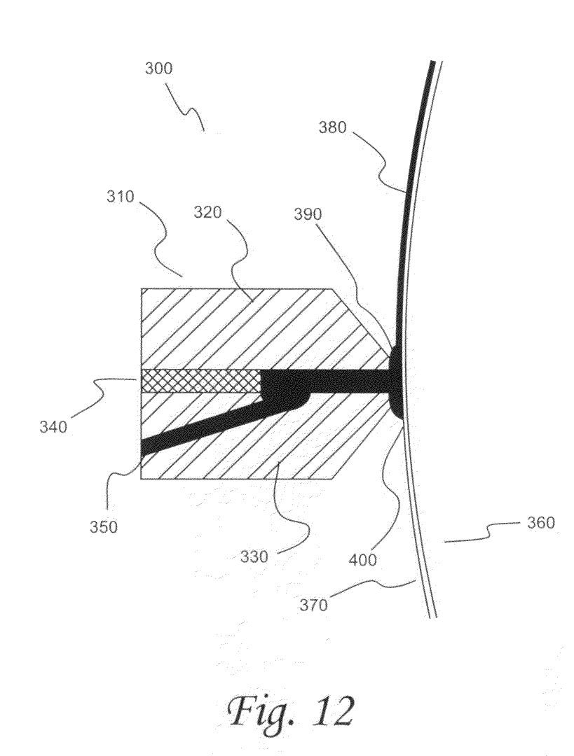

FIG. 12 depicts an exemplary slot-die coater found in the prior art. Slot-Die Coater 300 is shown in FIG. 12 situated against Roller 360 with Ribbon 370 wrapped around the circumference of Roller 360. Slot-Die 310 comprises an Upper Die Half 320 and a Lower Die Half 330 with Spacer 340 sandwiched between. Shown in black, the coating slurry is pumped through Coating Flow Path 350 into Slot 355. The slurry, which is under pressure, causes Slot-Die 310 to “float” upon the surface of Ribbon 370 as it passes by while rolling along Roller 360. During operation, Trailing Edge 400 is formed by vacuum pull-back created by a vacuum source, not shown, in fluid communication with Vacuum Region 310. Leading Edge 380 results from the combination of rotational movement of Ribbon 370 associated with Roller 360 and the viscosity and other rheological properties of the slurry. As a result of careful setup and control, Coating 380 is formed upon the surface of Ribbon 370. In use, slot-dies form a thick coat of slurry in one pass. Because the coat is thick, drying times are extended when compared to thin coats, and cracking becomes a problem if drying is done too quickly. Slow drying, however, can allow particles in the slurry to sediment based on size and density leading to potentially undesired stratification of materials in the electrode matrix of the coating.

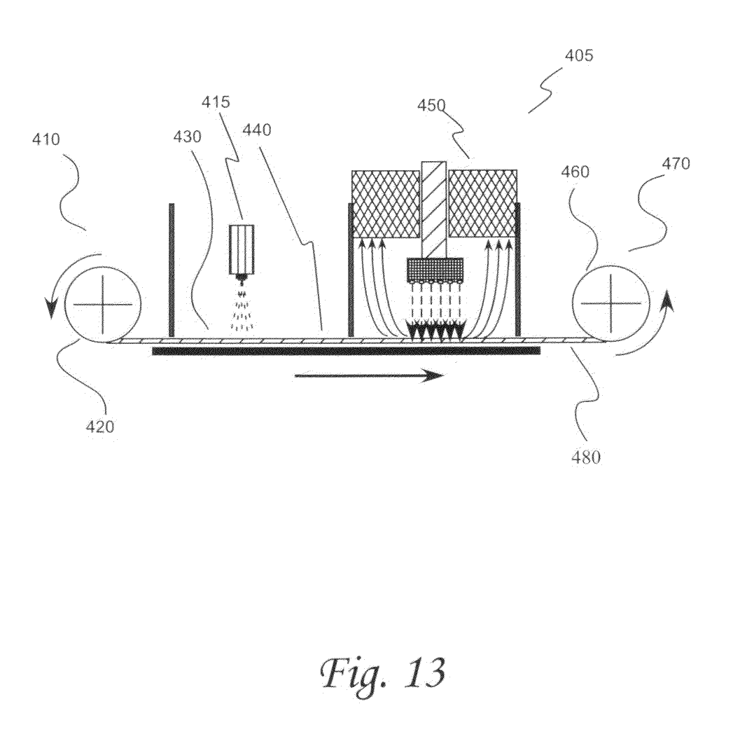

FIG. 13 depicts a preferred embodiment of the invention wherein electrodes are formed in whole or in-part by spray deposition. Spray System 405 is a reel-to-reel type “web converter” where the “web” is the support or separator to be coated. Unwinder 410 has therewith Roll 420 of Separator Ribbon 430. Separator Ribbon 430 is moved through Spray System 405 until it is rewound by Rewinder 470 onto Roll 460. Along the way, Separator Ribbon 430 is spray coated with a coating of either conductive material or active material matrix by Sprayer 415 to form Coated Region 440. As Separator Ribbon 430 moves along the Spray System 405, Coated Region 440 of Separator Ribbon 430 enters into Dryer 450 wherein solvent used in the spray coating, if any solvent was used, is removed. Dryer 450 may also be used to bond powder coatings if such are used for either the conductive layer or active material layer. Once dried or cured, Separator Ribbon 430 with its Coated Region 440 is wound up by Rewinder 470 for further processing.

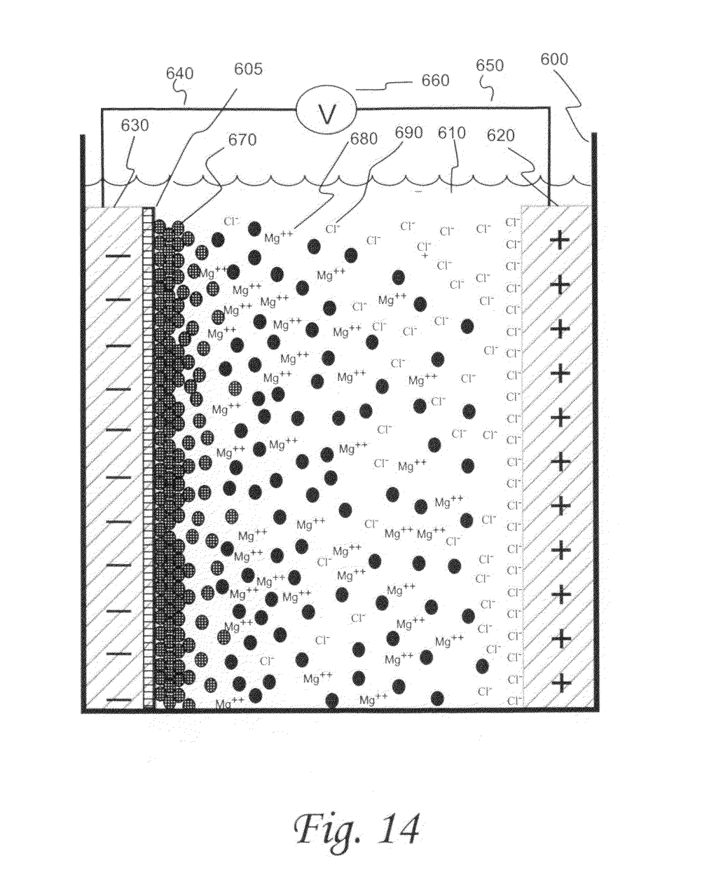

FIG. 14 depicts the use of electrophoretic deposition to coat a separator having a conductive coating applied thereto. Tank 600 contains Suspension 610 which contains Charged Particles 670, Positive Ions 680, and Negative Ions 690 in a solvent. Also contained within Tank 600 is Positive Electrode 620 and Support 630 having Separator 120 affixed thereto with the conductive coating, not shown, facing into the tank. Electrode 620 and Support/Separator 630/120 are situated in opposition to each other with Suspension 610 therebetween. Electrical Leads 640 (−) and 650(+) place Electrodes 620 and 630 in electrical communication with Power Supply 660. In operation, an electric potential is applied to Electrodes 620 and 630 to establish an electric field between Electrodes 620 and 630 to cause particles suspended in Suspension 610 to migrate towards Separator 120 by electrophoretic deposition. Once the particles arrive at the surface of Separator 120, they become neutral in charge associated with the surface of the electrode. The negative and positive ions are present to help impart a charge to otherwise uncharged components found in Suspension 610.

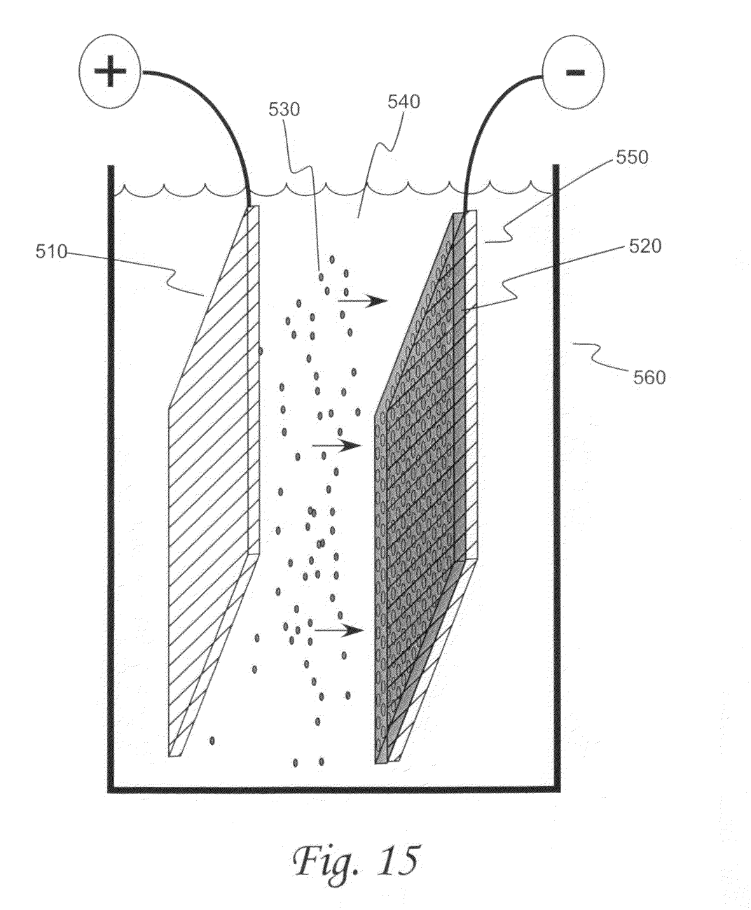

FIG. 15 depicts a perspective view of an apparatus for performing electrophoretic deposition to form an active material coated separator. Prior to electrophoretic deposition of the active material layer, a conductive layer comprising carbon black, carbon nanotubes, and binder was applied onto the separator surface to cause the surface to become electrically conductive so it could serve as an electrode during electrophoretic deposition of the active material. Tank 560 contains Solvent 540 and Particles 530, which can be active material, conductive material, or binder polymer. Also in Tank 560 is Positive Electrode 510 in electrical communication with a power source, not shown. In the opposite side of Tank 560 from Positive Electrode 510 is Support Plate 550 with Separator 520 coated with a conductive layer, not shown, is in electrical communication with the before mentioned power supply. When a potential is applied across Positive Electrode 510 and Separator 520, an electric field is established in Solvent 540 between Positive Electrode 510 and Separator 520. In the presence of the electric field, Particles 530, depending on their charge, will migrate to either Positive Electrode 510 or Separator 520. In the case of FIG. 15, Particles 530 have a net positive charge and are therefore attracted towards and onto Separator Plate 520 which is negatively charged. After a desired period of time, a coating of active material and conductive particles will accumulate upon the surface of Separator 520 to form a layer of active material with conductive particles thus forming an electrode.

### Surface Modification

In some embodiments, the electrode support surface may be made hydrophilic prior to the immersing step and/or the carbon nanotubes are deposited upon the hydrophilic layer. In particularly preferred embodiments, the hydrophilic layer comprises a polymer selected from the group consisting: acrylonitrile butadiene styrene (ABS); polyacrylonitrile (PAN) or Acrylic; polybutadiene; poly(butylene terephthalate) (PBT); poly(ether sulphone) (PES, PES/PEES); poly(ether ether ketone)s (PEEK, PES/PEEK); polyethylene (PE); poly(ethylene glycol) (PEG); poly(ethylene terephthalate) (PET); polypropylene (PP); polytetrafluoroethylene (PTFE); styrene-acrylonitrile resin (SAN); poly(trimethylene terephthalate) (PTT); polyurethane (PU); Polyvinyl butyral (PVB); polyvinylchloride (PVC); polyvinylidenedifluoride (PVDF); poly(vinyl pyrrolidone) (PVP); polyhydroxyethylmethacrylate (HEMA); butyl acrylate, 2-ethylhexyl acrylate, methyl acrylate, ethyl acrylate, acrylonitrile, methyl methacrylate, trimethylolpropane triacrylate (TMPTA), and, cyanoacrylate.

### Laminated Supports

Preferred embodiments of the invention may have the electrode support further comprise a conductive layer upon the electrode support surface with variants that include having: the conductive layer comprises carbon nanotubes; the conductive layer comprises an elemental metal, preferably on that is selected from the group consisting of: aluminum; copper, gold, nickel, or silver; the electrode support having bonded thereto a second substrate having properties different from the electrode support to form a laminate, the laminate being ion permeable, preferably where the laminate further comprises a third substrate bonded thereto to form a three-layer laminate that is ion permeable; the second substrate has electrically conductive properties; the electrode support has dielectric properties, preferably where the laminate has dielectric properties; the electrode support has conductive properties and the second substrate has dielectric properties the first and third substrates have electrically conductive properties, preferably where the electrode support comprises pores ranging in size from 0.1 nanometers to 1000 nanometers. Some particularly preferred embodiments of the invention include having the electrode support be permeable to lithium ions and/or where the nanoparticles are selected from the group consisting of: lithium, cobalt, manganese, silicon; carbon nanotubes; and, graphite.

### Coating/Deposition Methods

The invention provides, in certain embodiments, coating methods selected from the group comprising: spray deposition; electrostatic assisted spray deposition; electrokinetic deposition; electrophoretic deposition; mist deposition; curtain coating; slurry coating; slot-die coating; gravure coating; and, coating involving a doctor blade. Some embodiments of the invention provide for a second layer formation by immersing the electrode substrate into a second solvent bath having a counter electrode, a solvent, carbon nanotubes, and, nanoparticles, and applying an electrical potential to the counter electrode and the conductive layer upon the electrode support surface so that the carbon nanotubes and silicon nanoparticles deposit upon the electrode support surface. In particularly preferred embodiments, the nanoparticles comprise a material that can reversibly retain a metal atom.

### Cathode Materials

Preferred embodiments of the invention provide for a cathode material layer being deposited upon the electrode support, the cathode materials comprises materials including, but not limited to, gold; silver; silver oxide; silver chloride; lead; indium; indium oxide; tin; tin indium oxide; nickel; nickel tin oxide; ruthenium; ruthenium oxide; manganese; manganese oxide; aluminum; aluminum oxides; vanadium; vanadium oxide; iron; iron oxides; cobalt; cobalt oxides; tellurium; tellurium oxides; gallium; gallium oxides; tungsten; tungsten oxides; lithium; lithium oxides; polymers; protein; nucleic acid; lipid; mineral; salt; colloidal particles; sulfur; sulfur dioxide; thionyl dichloride; LiCoO₂; LiMn₂O₄; LiMnO₂; LiNiO₂; LiFePO₄; LiNiₓCO_{y}Mn_{z}O₂; metal fluoride; bismuth fluoride; bismuth oxyfluoride; copper difluoride; zinc; zinc nitride; and nitrides. In certain embodiments the formula CuMeₓF_{z}O_{w} wherein Me is selected from the group consisting of: iron; cobalt; nickel; manganese; vanadium; molybdenum; lead; antimony; bismuth; tin; niobium; chromium; silver; zinc; zinc nitride; and, nitrides. In particularly preferred embodiments, the cathode material comprises an alloy, for example, but not limited to, Li₂Mn₂₋ₓMeₓO_{4-z}F_{z} wherein said Me is selected from the group consisting of: aluminum; chromium; zinc; cobalt; nickel; lithium; magnesium; iron; copper; titanium; and, silicon, and wherein x and z range from 0 to 0.5.

### Anode Materials

Preferred embodiments of the invention provide for a anode material layer being deposited upon the electrode support, the anode materials comprises materials including, but not limited to: graphite; graphene; copper; copper oxides; silicon; silicon oxides; silicon nanoparticles; germanium; germanium oxides; Li4Ti₅O₁₂;

### Conductive Particles and Materials

The invention provides for embodiments where the deposited electrode layer comprises a conductive material. In some embodiments, the conductive material may comprise one or more of the following: tin, antimony, vanadium, chromium, titanium, manganese, iron, cobalt, nickel, copper, zinc, titanium, graphite; carbon black; carbon fibers; and, nanostructures. The conductive layer may be deposited from a suspension of conductive material particles having an average dimension ranging from 1 to 1000 nanometers, more preferably from 1 to 500 nanometers, still more preferably from 1 to 200 nanometers. In particularly preferred embodiments, the conductive material may be a nanostructure comprising carbon nanostructures including fullerenes, Buckminster fullerenes, carbon nanotubes are single walled and/or multiple walled. The nanostructures may have structural distortions and features, be spherical, oblong, tubular, or branched hollow structures with open and/or closed portions. In some embodiments, the carbon nanostructure has a surface that is charged and/or modified. Preferable methods for charging a nanostructure include exposing the nanostructures to acidic, basic, or oxidizing conditions with or without charged ions present. Nanostructure surface modification may include covalently, ionically, physically, or chemically attaching or adsorbing a charged material.

### Multilayer Supported Electrodes

The supported electrodes of the invention can, in some embodiments, be stacked together. Electrical communication between electrode layers may be achieved, in preferred embodiments, by using conductive interconnections between the conductive stacked electrodes. For example, but not limited to, using metal foil to form an electrically conductive trace from a first to a second electrode element.

### Electrolyte/Solvent Systems

Preferable solvents are dimethyl carbonate (DMC), methylethyl carbonate (MEC), diethyl carbonate (DEC), ethyl propionate, methyl propionate, propylene carbonate (PC), .gamma.-butyrolactone (.gamma.-BL), acetonitrile (AN), ethyl acetate (EA), propyl formate (PF), methyl formate (MF), toluene, xylene and methyl acetate (MA). These second solvents may be employed singly or in a combination of two or more. More desirably, this solvent should be selected from those having a donor number of 16.5 or less. The viscosity of this second solvent should preferably be 28 cps or less at 25.degree. C.

The mixing ratio of the aforementioned ethylene carbonate in a mixed solvent should preferably be 10 to 80% by volume. If the mixing ratio of the ethylene carbonate falls outside this range, the conductivity of the solvent may be lowered or the solvent tends to be more easily decomposed, thereby deteriorating the charge/discharge efficiency. More preferable mixing ratio of the ethylene carbonate is 20 to 75% by volume. When the mixing ratio of ethylene carbonate in a non-aqueous solvent is increased to 20% by volume or more, the solvating effect of ethylene carbonate to lithium ions will be facilitated and the solvent decomposition-inhibiting effect thereof can be improved.

Examples of preferred mixed solvents are a composition comprising EC and MEC; comprising EC, PC and MEC; comprising EC, MEC and DEC; comprising EC, MEC and DMC; and comprising EC, MEC, PC and DEC; with the volume ratio of MEC being controlled within the range of 30 to 80%. By selecting the volume ratio of MEC from the range of 30 to 80%, more preferably 40 to 70%, the conductivity of the solvent can be improved. With the purpose of suppressing the decomposition reaction of the solvent, an electrolyte having carbon dioxide dissolved therein may be employed, thereby effectively improving both the capacity and cycle life of the battery.

The electrolytic salts to be incorporated into a non-aqueous electrolyte may be selected from a lithium salt such as lithium perchlorate (LiClO.sub.4), lithium hexafluorophosphate (LiPF.sub.6), lithium borofluoride (LiBF.sub.4), lithium hexafluoroarsenide (LiAsF.sub.6), lithium trifluoro-metasulfonate (LiCF.sub.3SO.sub.3) and bis-trifluoromethyl sulfonylimide lithium [LiN(CF.sub.3SO.sub.2).sub.2]. Among them, LiPF.sub.6, LiBF.sub.4, and LiN(CF.sub.3SO.sub.2).sub.2 are preferred. The content of aforementioned electrolytic salts in the non-aqueous solvent is preferably 0.5 to 2.0 mol/l.

### Cell Configuration

Electrodes provided for by the invention may be arranged in a manner including, but not limited to, serpentine, co-planar; co-axial; zigzag; folded stack; folded staircase; wrinkled; non-planar; and spiral, flat spiral, and the electrodes are spaced apart by a separator or polymer electrolyte structure.

### Battery Uses

In another aspect of the invention, the resulting electrodes can be combined with electrodes made by one of deposition methods of the invention, or by a different electrode forming method. Exemplary uses of the resulting batteries include, but are not limited to, incorporation into a system selected from the group consisting of uninterrupted power supply; audio headset; wireless headset; portable telephone; cellular phone; satellite telephone; portable digital imaging; camcorder; portable video game player; portable medical diagnostic; portable defibrillator; pacemaker; portable drug infusion pump; uninterrupted power supply; photographic light flash unit; prop-up battery; automobile power storage; handheld radar device; portable computational device; and, laptop computer.

### EXAMPLES

### Example 1

### Preparation of Support

The surfaces of two 25 mm by 75 mm porous polyethylene battery separator membranes were exposed to plasma for 10 minutes. A poly-(hydroxymethyl methacrylate) (pHEMA) coating was then applied to the treated separator membrane. Monomeric HEMA was mixed with water at a 5% v/v ratio to which the catalyst FeCl₂ was added to yield a final FeCl₂ solution molarity of 2.5×10⁻⁴. The treated separator membrane was promptly immersed into the HEMA solution for 3 hours, removed from the solution, rinsed with water, rinsed in ethanol, and allowed to air dry.

### Example 2

### Separator Membrane Mounting

The plasma treated membrane was placed upon an aluminum foil sheet covering one side of a 25 mm by 75 mm standard microscope slide to form a membrane/foil/glass slide sandwich and was held together with small binder clips to form a membrane-electrode sandwich.

### Example 3

### Preparing Stock Nanotube Solution

Multi-walled carbon nanotubes (MWCNTs) were readied by suspending 2400 mg of MWCNT in 160 ml of 15.6M H₂(NO₃) and refluxed for 10 hours using an oil bath at 125° C. and collected and dried by filtration. The average length and diameter of the MWCNTs ranged from 5 to 50 μm and 2-25 nm, respectively. After drying, 60 mg of the acid treated MWCNTs was suspended in 20 ml of 200 proof ethanol in a beaker placed for 45 minutes placed in a 70 watt ultrasonic cleaning water bath operating at 40 kHz to yield a stock MWCNT solution.

### Example 4

### Cathode Nanoparticles

LiNi_{1/3}Mn_{1/3}CO_{1/3}O₂ nanoparticles were formed by the following method. The following aqueous solutions were combined:

| | | |
|---|---|---|
| 1.0M | LiNO3 | 20.0 ml |
| 0.5M | Co(NO₃)₂ | 13.5 ml |
| 0.5M | Ni(NO₃)₂ | 13.5 ml |
| 0.5M | Mn(NO₃)₂ | 13.5 ml |

To the above mixture was added 5.7 grams of citric acid. The mixture was constantly stirred while on a hotplate. The mixture temperature was brought to 180° C. and then ramped over a one hour period to a final temperature of 280° C. where the mixture began to boil and degas. After one hour at 280° C., the mixture yielded a loose brown powder. The powder was pulverized with a laboratory mortar and pestle, placed in a 50 cc alumina crucible, and sintered in a small box furnace at 700° C. for three hours to yield a dark brown powder. The resulting powder was used in the electrode formation process described below.

### Example 5

### Depositing a Conductive Layer

The stock MWCNT solution was diluted by adding enough 200 proof ethanol to 1.8 ml of stock MWCNT to a final volume of 20 ml in a beaker and was placed in a sonicating water bath for 20 minutes. To the diluted MWCNT mixture was added 15 mg of Mg(NO₃)₂ by way of a stock 50 mg/ml Mg(NO₃)₂ solution. The MWCNT mixture beaker was placed in a sonicating water bath for 10 minutes and then poured into a tray having a graphite counter electrode located against an interior wall of the tray submerging the graphite electrode in the mixture. The prepared membrane/electrode sandwich was then immersed in mixture within the tray and situated on the side of the tray opposite the counter electrode. An electrical potential was applied from an external power supply across the electrodes with the foil adjacent the membrane being the negative pole. The electrical current was held constant (2.5 mA/cm²) while power was supplied for 30 seconds to deposit form an electrically conductive MWCNT layer upon the exposed surface of the separator membrane. The sandwich was then removed from the tray and allowed to air dry.

### Example 6

### Depositing an Anode Active Material Layer

A MWCNT and silicon nanoparticle (MWCNT/SiNP)/ethanol stock solution was made by diluting 1.8 ml of the stock MWCNT solution and 12.6 mg of dry silicon nanoparticles to 20 ml total volume using 200 proof ethanol. The MWCNT/SiNP stock solution was placed in the ultrasonication bath for 30 minutes. To the MWCNT/SiNP stock solution was added 45 mg of Mg₂(NO₃)₂ then diluted to 60 ml total volume with 200 proof ethanol and placed in the ultrasonication bath for 5-10 minutes.

Using the MWCNT/Si nanoparticle stock solution, a second layer active material layer was then coated upon the electrically conductive MWCNT layer to form a active material layer by the following process. The membrane/electrode/slide sandwich was removed from the tray so that a strip of aluminum foil could be placed at each end of the slide length in direct contact with the conductive MWCNT layer to facilitate electrical communication of the MWCNT layer with the external power supply. A constant current electrical potential was applied between the MWCNT layer and the graphite counter electrode and held between 30 and 40 milliamps for 30 seconds. The sandwich was then removed and allowed to air dry. During the drying step, the MWCNT/SiNP solution was subjected to further ultrasonication to prevent aggregation of the suspended nanoparticles. An additional 30 second immersion in the MWCNT/SiNP solution with constant electrical current exposure was performed followed by an additional six rounds of 60 second immersion/exposures to build up the thickness of the resulting MWCNT/SiNP layer. Between each round, the solution was further ultrasonicated to prevent aggregation of the MWCNT nanotubes and SiNP nanoparticles.

### Example 7

### Depositing a Cathode Active Material Layer

To 62.1 mg of the LiNi_{1/3}Mn_{1/3}CO_{1/3}O₂ nanoparticles from the above example was added 5.4 mg of CNT by way of the stock CNT solution described above to which 15 mg of Mg(NO3)2 was then added. The suspension was subjected to ultrasonication as described above. The ultrasonicated suspension was then used to perform the deposition method described above with the following parameters: 2.5 mA/cm² constant current.

### Example 8

### Depositing an Outer Conductive Layer

Like above, a second diluted MWCNT mixture was made and to it 15 mg of Mg(NO₃)₂ was added by way of a stock 50 mg/ml Mg(NO₃)₂ solution. The MWCNT mixture was placed in the cleaner bath for 10 minutes and then poured into a tray having a graphite counter electrode located against an interior wall of the tray thereby submerging the graphite electrode in the mixture.

The MWCNT-MWCNT/SiNP coated membrane/electrode sandwich was then immersed in mixture into the tray and situated on the side of the tray opposite the counter electrode. An electrical potential was applied from an external power supply across the electrodes with the foil adjacent the membrane being the negative pole. The electrical current was held constant and ranged from 30 to 40 milliamps as the power was supplied for 30 seconds to deposit form an electrically conductive MWCNT layer upon the previously formed MWCNT/SiNP layer. The membrane sandwich was then removed form the mixture and allowed to air dry.

### Example 9

### Cell Assembly

The electrode materials described in the Examples above were tested in a full-cell environment by making coin cells from the

[symbol]

1. A method of making a battery electrode comprising the steps of:
a. providing an ion permeable electrically insulating substrate having a surface;
b. applying an active material suspension onto said substrate surface to produce an active material layer having first and second active material layer surfaces, said first active material layer surface being adjacent to said substrate surface, said active material suspension comprising:
i. active material particles capable of reversibly lithiating and de-lithiating;
ii. conductive particles capable of conducting electrons; and,
iii. binder polymer;
c. applying a conductive layer upon said active material layer wherein said conductive layer is in electrical communication with said coating layer.

2. The method of claim 1 wherein said substrate comprises a battery separator.

3. The method of claim 2 wherein said battery separator is suitable for use in lithium ion batteries.

4. The method of claim 2 wherein said battery separator comprises a material selected from the group consisting of: polyethylene oxide (PEO), polyvinylidene fluoride (PVDF), polytetrafluoroethylene (PTFE), polyurethane, polyacrylonitrile (PAN), polymethylmethacrylate (PMMA), polytetraethylene glycol diacrylate, and, copolymer.

5. The method of claim 2 wherein said battery separator has a first microporous membrane and a second ceramic composite layer, wherein said ceramic composite layer consists of a porous polymer matrix material and inorganic particles, said inorganic particles being selected from the group of inorganic particles consisting of: silicon dioxide (SiO₂); aluminum oxide (Al₂O₃); calcium carbonate (CaCO₃); titanium dioxide (TiO₂); SiS₂; and, SiPO₄.

6. The method of claim 5 wherein said inorganic particles makes up from 5% to 80% by weight of said ceramic composite layer.

7. The method of claim 5 wherein said inorganic particles makes up from 40% to 60% by weight of said ceramic composite layer.

8. The method of claim 1 wherein said support comprises a polymer selected from the group consisting of: polyacrylates (AA); acrylonitrile-butadiene-styrene (ABS); ethylene vinyl alcohol (E/VAL); fluoroplastics (PTFE), (FEP, PFA, CTFE); high impact polystyrene (HIPS); melamine formaldehyde (MF); poly liquid crystal polymer (LCP); polyacetal (POM); acrylo nitrile (PAN); phenol-formaldehyde plastic (PF); polyamide (PA); polyamide-imide (PAI); polyaryletherketone (PAEK)′ polyetheretherketone (PEEK); 2. cis 1,4-poly butadiene (PBD); trans 1,4-poly butadiene (PBD); poly 1-butene (PB); poly butylene terephthalate (PBT); poly caprolactam; poly carbonate (PC); polycarbonate/acrylonitrile butadiene styrene (PC/ABS); poly 2,6-dimethyl-1,4-phenylene ether (PPE); polydicyclopentadiene (PDCP); polyester (PL); poly ether ether ketone (PEEK); poly etherimide (PEI); poly ethylene (PE, LDPE, MDPE, HDPE, UHDPE); polyethylenechlorinates (PEC); poly(ethylene glycol) (PEG); poly ethylene hexamethylene dicarbamate (PEHD); poly ethylene oxide (PEO); polyethersulfone (PES); poly ethylene sulphide (PES); poly ethylene terephthalate (PET); Phenolics (PF); poly hexamethylene adipamide (PHMA); poly hexamethylene sebacamide (PHMS); polyhydroxyethylmethacrylate (HEMA)poly imide (PI); poly isobutylene (PIB); polyektone (PK); polylactic acid (PLA); poly methyl methacrylate (PMMA); poly methyl pentene (PMP); poly m-methyl styrene (PMMS); poly p-methyl styrene (PPMS); poly oxymethylene (POM); poly pentamethylene hexamethylene dicarbamate (PPHD); poly m-phenylene; isophthalamide (PMIA); poly phenylene oxide (PPO); poly p-phenylene sulphide (PPS); poly p-phenylene terephthalamide (PPTA); polyphthalamide (PTA); poly propylene (PP); poly propylene oxide (PPDX); poly styrene (PS); polysulfone (PSU); poly tetrafluoro; ethylene (PTFE); poly(trimethylene terephthalate) (PTT); poly polyurethane (PU); Polyvinyl butyral (PVB); poly vinyl chloride (PVC); polyvinylidene chloride (PVDC); poly vinyledene fluoride (PVDF); poly vinyl methyl ether (PVME); poly(vinyl pyrrolidone) (PVP)silicone(SI); styrene-acrylonitrile resin (SAN); thermoplastic elastomers (TPE); thermoplastic polymer (TP); and, urea-formaldehyde (UF).

9. The method of claim 1 wherein the electrode support may act in a way that helps to prevent thermal runaway resulting from dendrite formation within the battery in that the electrode support comprises two or more layers of polymer sheets with different melting points being laminated to provide the electrode support, when used as a battery separator, with thermal shutdown capability.

10. The method of claim 1 wherein said support surface further comprises a hydrophilic coating upon said surface.

11. The method of claim 10 wherein said hydrophilic coating comprises a polymer selected from the group consisting: acrylonitrile butadiene styrene (ABS); polyacrylonitrile (PAN) or Acrylic; polybutadiene; poly(butylene terephthalate) (PBT); poly(ether sulphone) (PES, PES/PEES); poly(ether ether ketone)s (PEEK, PES/PEEK); polyethylene (PE); poly(ethylene glycol) (PEG); poly(ethylene terephthalate) (PET); polypropylene (PP); polytetrafluoroethylene (PTFE); styrene-acrylonitrile resin (SAN); poly(trimethylene terephthalate) (PTT); polyurethane (PU); Polyvinyl butyral (PVB); polyvinylchloride (PVC); polyvinylidenedifluoride (PVDF); poly(vinyl pyrrolidone) (PVP); polyhydroxyethylmethacrylate (HEMA); butyl acrylate, 2-ethylhexyl acrylate, methyl acrylate, ethyl acrylate, acrylonitrile, methyl methacrylate, trimethylolpropane triacrylate (TMPTA), and, cyanoacrylate.

12. The method of claim 1 wherein said applying step comprises a coating method selected from the group consisting of: spray deposition; electrostatic assisted spray deposition; electrokinetic deposition; electrophoretic deposition; mist deposition; curtain coating; slurry coating; slot-die coating; gravure coating; and, coating involving a doctor blade.

13.-18. (canceled)

19. The method of claim 1 wherein said active material comprises a material selected from the group consisting of: LiCoO₂; LiMn₂O₄; LiMnO₂; LiNiO₂; LiFePO₄; Li₄Ti₅O₁₂; and, LiNiₓCO_{y}Mn_{z}O₂.

20. (canceled)

21. The method of claim 1 wherein said active material suspension is applied to said substrate surface by spraying.

22.-33. (canceled)

34. A battery electrode comprising:
a. a substrate, said substrate having a surface and being ion permeable electrically insulating;
b. an active material layer having first and second active material layer surfaces, said first active material layer surface being bonded to said substrate surface, said active material layer comprising:
i. active material particles capable of reversibly lithiating and de-lithiating;
ii. conductive particles capable of conducting electrons; and,
iii. binder polymer;
c. a conductive layer upon said active material layer, wherein said conductive layer is in electrical communication with said active material layer.

35.-36. (canceled)

37. The battery electrode of claim 34 wherein said substrate comprises a battery separator membrane.

38.-44. (canceled)

45. The battery electrode of claim 34 wherein said conductive particles in said active material layer comprise carbon nanotubes.
